(19) United States
(12) Patent Application Publication
(10) Pub. No.: US 2022/0210127 A1
(43) Pub. Date: Jun. 30, 2022

(54) ATTRIBUTE-BASED FIREWALL RULE ENFORCEMENT

(71) Applicant: VMWARE, INC., Palo Alto, CA (US)

(72) Inventors: VASANTHA KUMAR DHANASEKAR, Pune (IN); Shirish VIJAYVARGIYA, Pune (IN); Rayanagouda Bheemanagouda PATIL, Pune (IN)

(21) Appl. No.: 17/177,257

(22) Filed: Feb. 17, 2021

(30) Foreign Application Priority Data
Dec. 29, 2020 (IN) 202041056827

(51) Int. Cl. H04L 29/06; H04L 9/32

(52) U.S. Cl. CPC H04L 63/0263; H04L 9/3236; H04L 63/0218; H04L 63/0236

(57) ABSTRACT

Example methods and systems for attribute-based firewall rule enforcement are described. One example method may comprise a computer system obtaining, from a management entity, one or more first firewall rules configured based on first attribute information. The computer system may detect a login event associated with a user operating a user device to log onto a virtualized computing instance. In response to determination that the user is associated with the first attribute information, the one or more first firewall rules may be applied. Otherwise, in response to determination that the user is associated with second attribute information that is different from the first attribute information, the computer system may obtain and apply one or more second firewall rules configured based on the second attribute information.

### RELATED APPLICATIONS

Benefit is claimed under 35 U.S.C. 119(a)-(d) to Foreign Application Serial No. 202041056827 filed in India entitled “ATTRIBUTE-BASED FIREWALL RULE ENFORCEMENT”, on Dec. 29, 2020, by VMware, Inc., which is herein incorporated in its entirety by reference for all purposes.

### BACKGROUND

Virtualization allows the abstraction and pooling of hardware resources to support virtual machines in a software-defined networking (SDN) environment, such as a software-defined data center (SDDC). For example, through server virtualization, virtual machines running different operating systems may be supported by the same physical machine (also referred to as a “host”). Each virtual machine is generally provisioned with virtual resources to run an operating system and applications. The virtual resources may include central processing unit (CPU) resources, memory resources, storage resources, etc. In order to meet requirements of granularity and scalability in the SDN environment, a firewall engine may be deployed on each host to protect VMs against security threats. For example, after a user logs onto a particular VM to access various resources in the SDN environment, the firewall engine may be configured to filter traffic to and from the VM .

### BRIEF DESCRIPTION OF DRAWINGS

FIG. 1 is a schematic diagram illustrating an example software-defined networking (SDN) environment in which attribute-based firewall rule enforcement may be performed;

FIG. 2 is a schematic diagram illustrating an example attribute-based firewall rule enforcement in an SDN environment;

FIG. 3 is a flowchart of an example process for a computer system to perform attribute-based firewall rule enforcement in an SDN environment;

FIG. 4 is a flowchart of an example detailed process for attribute-based firewall rule enforcement in an SDN environment;

FIG. 5 is a schematic diagram illustrating first example of attribute-based firewall rule enforcement in an SDN environment;

FIG. 6 is a schematic diagram illustrating second example of attribute-based firewall rule enforcement in an SDN environment; and

FIG. 7 is a schematic diagram illustration an example selection of common attribute combinations for attribute-based firewall rule enforcement.

### DETAILED DESCRIPTION

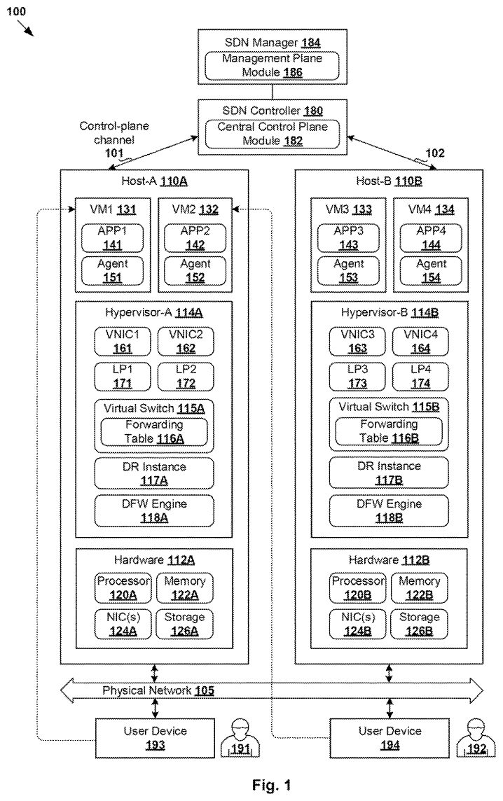

According to examples of the present disclosure, attribute-based firewall rule enforcement may be implemented to enhance data center security. One example may involve a computer system (e.g., host-A 110A in FIG. 1) obtaining, from a management entity (e.g., SDN manager 184), first firewall rule(s) configured based on first attribute information. The computer system may then detect a login event associated with a user operating a user device (e.g., user 191 and device 193) to log onto a virtualized computing instance (e.g., VM1 131). In response to determination that the user is associated with the first attribute information, the first firewall rule(s) may be applied. Otherwise, in response to determination that the user is associated with second attribute information that is different from the first attribute information, the computer system may obtain second firewall rule(s) configured based on the second attribute information. This way, the second firewall rule(s) may be applied to allow or block packet forwarding towards or from the virtualized computing instance.

Using examples of the present disclosure, first firewall rule(s) may be obtained by the computer system for later application during packet forwarding. This has the effect of caching or storing the first firewall rule(s) to improve efficiency at the computer system. Since login events may occur in burst in practice, this also improves scalability by reducing the amount of traffic to the management entity every time there is a login event. Examples of the present disclosure should be contrasted against conventional approaches that necessitate the computer system to store a large number of firewall rules configured for various possibilities of attribute information.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Throughout the present disclosure, it should be understood that although the terms “first” and “second” are used to describe various elements, these elements should not be limited by these terms. These terms are used to distinguish one element from another. A first element may be referred to as a second element, and vice versa.

FIG. 1 is a schematic diagram illustrating example software-defined networking (SDN) environment 100 in which attribute-based firewall rule enforcement may be performed. It should be understood that, depending on the desired implementation, SDN environment 100 may include additional and/or alternative components than that shown in FIG. 1. SDN environment 100 includes multiple hosts 110A-B that are inter-connected via physical network 105. In practice, SDN environment 100 may include any number of hosts (also known as a “host computers”, “host devices”, “physical servers”, “server systems”, “transport nodes,” etc.), where each host may be supporting tens or hundreds of virtual machines (VMs).

Each host 110A/110B may include suitable hardware 112A/112B and virtualization software (e.g., hypervisor-A 114A, hypervisor-B 114B) to support various VMs. For example, hosts 110A-B may support respective VMs 131-134. Hypervisor 114A/114B maintains a mapping between underlying hardware 112A/112B and virtual resources allocated to respective VMs. Hardware 112A/112B includes suitable physical components, such as central processing unit(s) (CPU(s)) or processor(s) 120A/120B; memory 122A/122B; physical network interface controllers (NICs) 124A/124B; and storage disk(s) 126A/126B, etc.

Virtual resources are allocated to respective VMs 131-134 to support a guest operating system (OS; not shown for simplicity) and application(s) 141-144. For example, the virtual resources may include virtual CPU, guest physical memory, virtual disk, virtual network interface controller (VNIC), etc. Hardware resources may be emulated using virtual machine monitors (VMMs). For example in FIG. 1, VNICs 161-164 are virtual network adapters for VMs 131-134, respectively, and are emulated by corresponding VMMs (not shown for simplicity) instantiated by their respective hypervisor at respective host-A 110A and host-B 110B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 114A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

Hypervisor 114A/114B implements virtual switch 115A/115B and logical distributed router (DR) instance 117A/117B to handle egress packets from, and ingress packets to, corresponding VMs. In SDN environment 100, logical switches and logical DRs may be implemented in a distributed manner and can span multiple hosts. For example, logical switches that provide logical layer-2 connectivity, i.e., an overlay network, may be implemented collectively by virtual switches 115A-B and represented internally using forwarding tables 116A-B at respective virtual switches 115A-B. Forwarding tables 116A-B may each include entries that collectively implement the respective logical switches. Further, logical DRs that provide logical layer-3 connectivity may be implemented collectively by DR instances 117A-B and represented internally using routing tables (not shown) at respective DR instances 117A-B. The routing tables may each include entries that collectively implement the respective logical DRs.

Packets may be received from, or sent to, each VM via an associated logical port. For example, logical switch ports 171-174 are associated with respective VMs 131-134. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 115A-B in FIG. 1, whereas a “virtual switch” may refer generally to a software switch or software implementation of a physical switch. In practice, there is usually a one-to-one mapping between a logical port on a logical switch and a virtual port on virtual switch 115A/115B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

Through virtualization of networking services in SDN environment 100, logical networks (also referred to as overlay networks or logical overlay networks) may be provisioned, changed, stored, deleted and restored programmatically without having to reconfigure the underlying physical hardware architecture. A logical network may be formed using any suitable tunneling protocol, such as Virtual eXtensible Local Area Network (VXLAN), Stateless Transport Tunneling (STT), Generic Network Virtualization Encapsulation (GENEVE), etc. For example, VXLAN is a layer-2 overlay scheme on a layer-3 network that uses tunnel encapsulation to extend layer-2 segments across multiple hosts which may reside on different layer 2 physical networks. In the example in FIG. 1, VM1 131 on host-A 110A and VM3 133 on host-B 110B may be connected to the same logical switch and located on the same logical layer-2 segment, such as a segment with VXLAN network identifier (VNI)=6000.

SDN controller 180 and SDN manager 184 are example network management entities in SDN environment 100. One example of an SDN controller is the NSX controller component of VMware NSX® (available from VMware, Inc.) that operates on a central control plane. SDN controller 180 may be a member of a controller cluster (not shown for simplicity) that is configurable using SDN manager 184 operating on a management plane. Network management entity 180/184 may be implemented using physical machine(s), VM(s), or both. Logical switches, logical routers, and logical overlay networks may be configured using SDN controller 180, SDN manager 184, etc. To send or receive control information, a local control plane (LCP) agent (not shown) on host 110A/110B may interact with central control plane (CCP) module 182 at SDN controller 180 via control-plane channel 101/102.

Hosts 110A-B may also maintain data-plane connectivity with each other via physical network 105 to facilitate communication among VMs located on the same logical overlay network. Hypervisor 114A/114B may implement a virtual tunnel endpoint (VTEP) (not shown) to encapsulate and decapsulate packets with an outer header (also known as a tunnel header) identifying the relevant logical overlay network (e.g., using a VXLAN (or “virtual” network identifier (VNI) added to a header field). For example in FIG. 1, hypervisor-A 114A implements a first VTEP associated with (IP address=IP-A, MAC address=MAC-A, VTEP label=VTEP-A), and hypervisor-B 114B a second VTEP with (IP-B, MAC-B, VTEP-B), etc. Encapsulated packets may be sent via an end-to-end, bi-directional communication path (known as a tunnel) between a pair of VTEPs over physical network 105.

To protect VMs 131-134 against security threats caused by unwanted packets, hypervisor 114A/114B implements distributed firewall (DFW) engine 119A/119B to filter packets to and from associated VMs. For example, at host-A 110A, hypervisor 114A implements DFW engine 118A to filter packets for VM1 131 and VM2 132. SDN controller 160 may be used to configure firewall rules that are enforceable by distributed firewall engine 119A/119B. In practice, network packets may be filtered according to firewall rules at any point along the datapath from a source (e.g., VM1 131) to a physical NIC (e.g., 124A). In one embodiment, a filter component (not shown) may be incorporated into each VNIC 141-144 to enforce firewall rules that are associated with the VM (e.g., VM1 131) corresponding to that VNIC (e.g., VNIC 161). The filter components may be maintained by DFW engines 118A-B.

One of the challenges in SDN environment 100 is improving the overall data center security. Firewall rules are generally defined using five tuples to match a specific packet flow, such as source IP address, source port number (PN), destination IP address, destination PN, and protocol, in addition to an action (e.g., allow or block). To achieve better security in SDN environment 100, identity-based firewall rules that are applicable to a specific user (or group of users) may be configured. In practice, network administrators may find it easier and more efficient to configure identity-based firewall rules. As a comparison, to achieve the same level of protection for a group of users, a large set of traditional firewall rules may be required to cover all possible 5-tuple combinations.

For example in FIG. 1, first user 191 (user ID=X) may log onto VM1 131, and second user 192 (user ID=Y) into VM2 132 using respective user devices 193-194. Both users 191-192 are members of group=DOCTOR, and an identity-based firewall rule may be configured for that group. To facilitate the enforcement of firewall rules by DFW engines 118A-B, identity information associated with user 191/192 may be gathered when user 191/192 logs in. During the login process, authentication is performed to verify the identity of user 191/192 based on any suitable credentials (e.g., user or login name, user identifier (ID) and password).

For an identity-based firewall, whenever user 191/192 logs onto VM 131/132, DFW engine 118A may obtain identify and/or group membership information associated with user 191/192 from VM agent 151/152. Based on the identify and/or group membership information, DFW engine 118A may retrieve firewall rules that are applicable to user 191/192 from SDN manager 184 on the management plane. This approach generally lacks efficiency and does not scale well because the retrieval process has to be repeated every time there is a login event. Also, the retrieval process may take some time (e.g., seconds) depending on network conditions, which delays firewall rule enforcement and potentially exposes host-A 110A to security threats.

Another conventional approach is to push all firewall rules to hosts 110A-B prior to the login events. This way, after every login event, DFW engine 118A may perform a local search instead of retrieving firewall rules that are applicable to user 191/192 from SDN manager 184. However, this approach necessitates hosts 110A-B to store a very large set of firewall rules for users who are members of a large number of groups. This also lacks efficiency and scalability, especially as the number of users and the size of their group membership increases. Further, to achieve better performance, DFW engine 118A generally trusts the information received from agent 151/152. This exposes SDN environment 100 to potential security threats due to identity spoofing by malicious third parties.

Attribute-Based Firewall Rule Enforcement

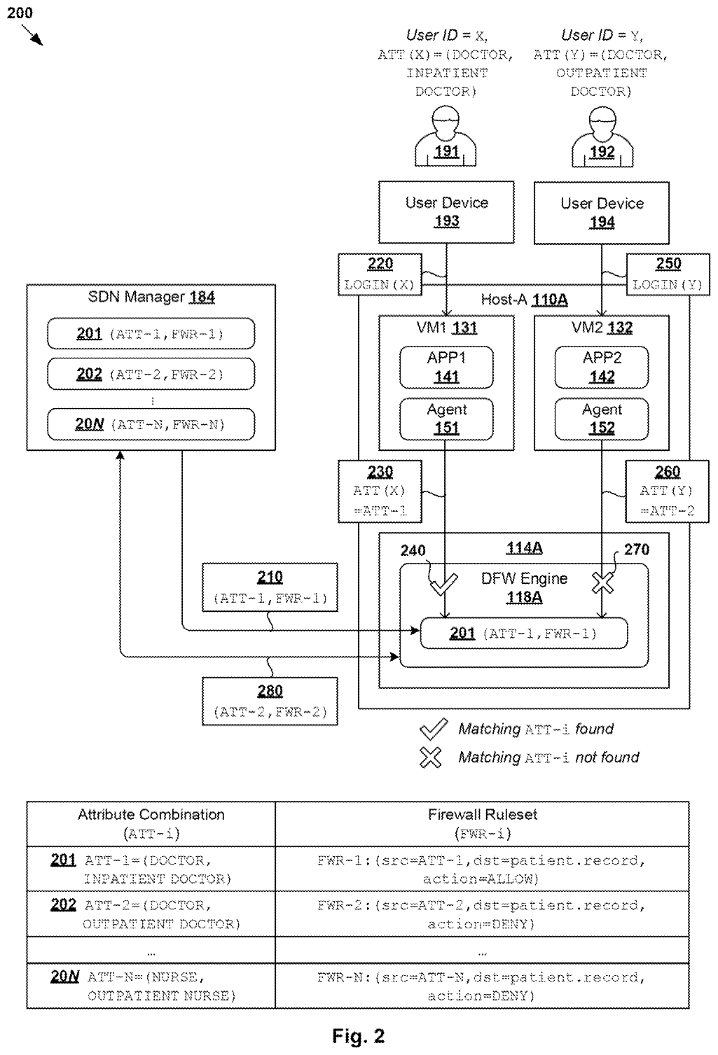

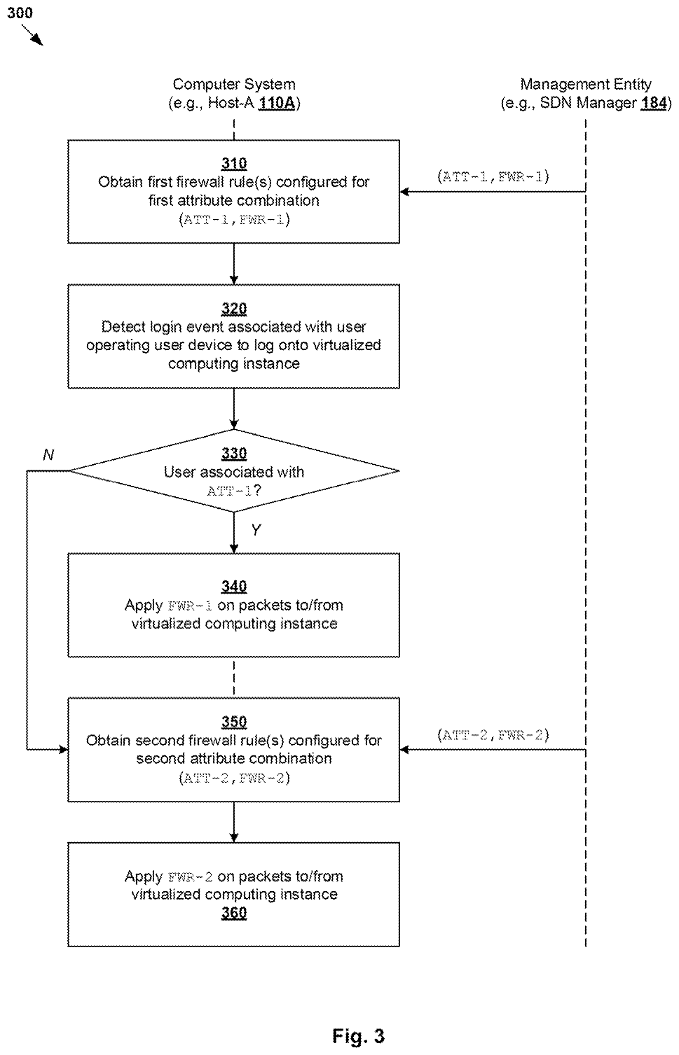

According to examples of the present disclosure, attribute-based firewall rule enforcement may be implemented to improve efficiency and scalability to enhance data center security. In the following, some examples will be explained using FIGS. 2-3. In particular, FIG. 2 is a schematic diagram illustrating example attribute-based firewall rule enforcement 200 in SDN environment 100. FIG. 3 is a flowchart of example process 300 for a computer system to perform attribute-based firewall rule enforcement in SDN environment 100. Example process 300 may include one or more operations, functions, or actions illustrated by one or more blocks, such as 310 to 360. The various blocks may be combined into fewer blocks, divided into additional blocks, and/or eliminated depending on the desired implementation. Examples of the present disclosure may be implemented using any suitable network management entity 180/184, host 110A/110B (e.g., using DFW engine 118A/118B and/or agent 151/152 running on VM 131/132), etc.

Referring first to FIG. 2, SDN manager 184 may configure and store multiple (N) sets of firewall rule(s) for different sets of attribute information. For example, at 201, first attribute information (ATT-1) may specify a combination of two groups, i.e., first group=DOCTOR and second group=INPATIENT DOCTOR). First firewall rule (FWR-1) is configured to allow a user associated with ATT-1=(DOCTOR, INPATIENT DOCTOR) to access patient records (e.g., allow packets that are sent by the user to a patient record server).

In contrast, at 202, second firewall rule (FWR-2) is configured to block a user associated with ATT-2=(DOCTOR, OUTPATIENT DOCTOR) from accessing patient records (i.e., block packets to the patient record server). At 20N, the N^{th} firewall rule (FWR-N) is configured to block a user associated with the N^{th} attribute information, ATT-N=(NURSE, OUTPATIENT NURSE), from accessing patient records. In the following, ATT-i may be used to denote the i^{th} attribute information and FWR-i the corresponding firewall rule(s) configured for that attribute information.

At 210 in FIGS. 2 and 310 in FIG. 3, host-A 110A may obtain, from SDN manager 184, first firewall rule(s) configured based on first attribute information denoted as (ATT-1, FWR-1) shown at 201. The term “obtain” may refer generally to receiving or retrieving firewall rule(s) from SDN manager 184 or a datastore accessible by the SDN manager 184. Block 310 has the effect of caching or storing (ATT-1, FWR-1) prior to detecting login events. This should be contrasted against the conventional approaches of obtaining all sets of (ATT-i, FWR-i) for all i=1, . . . , N, or fetching (ATT-1, FWR-1) every time there is a login event.

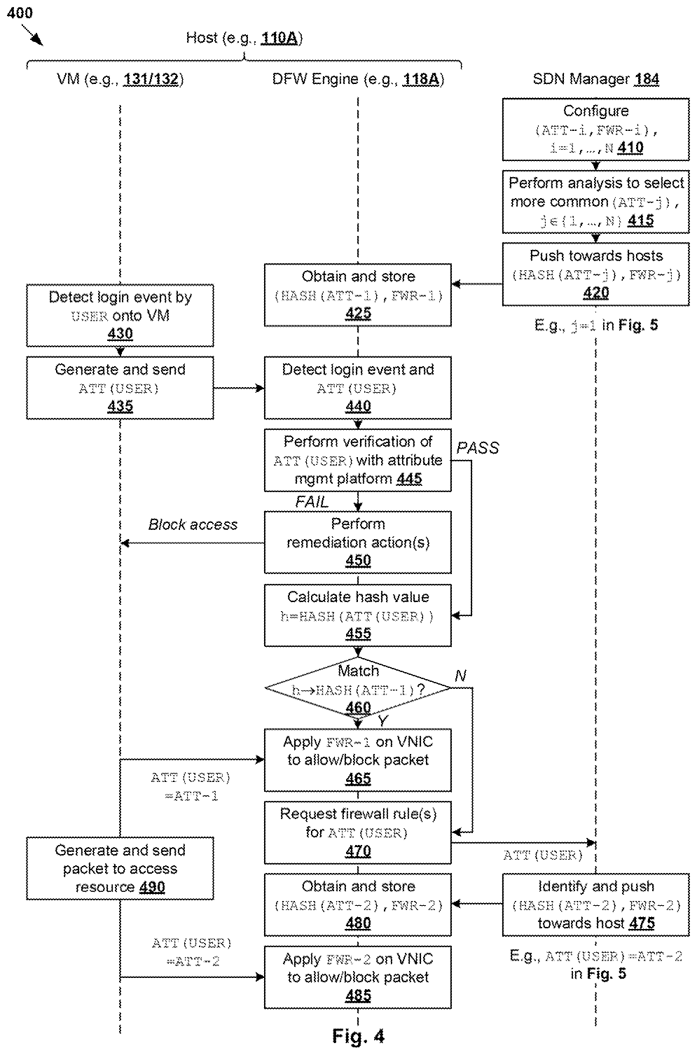

As will be described further using FIGS. 4-7, the first attribute information (ATT-1) may be a more “common attribute combination” compared to the second attribute information (ATT-2). The selection of ATT-1 over ATT-2 may be performed by SDN manager 184 based on any suitable selection criterion or criteria. Examples include (a) real-world occurrence associated with the first attribute information among all possible attribute combinations (e.g., 201-20N) and (b) real-world occurrence associated with the first attribute information for particular host-A 110A or across multiple hosts 110A-B.

At 220 in FIGS. 2 and 320 in FIG. 3, host-A 110A (e.g., using VM agent 151) may detect a login event associated with first user 191 operating first user device 193 to log onto VM1 131. In this example, first user 191 may be associated with user identifier (ID)=X and first attribute information in the form of group membership information=(DOCTOR, INPATIENT DOCTOR). In practice, in response to detecting login event 220, VM agent 151 may send the first attribute information (i.e., ATT(X)=ATT-1) associated with first user 191 to DFW engine 118A. See also 230 in FIG. 2.

At 240 in FIGS. 2 and 330 in FIG. 3, in response to determination that first user 191 is associated with ATT-1, host-A 110A (e.g., using DFW engine 118A) may apply the first firewall rule(s) to allow or block packet forwarding towards, or from, VM1 131. Using FWR-1 as an example, any packet(s) from VM1 131 to access patient record(s) will be allowed by DFW engine 118A.

Otherwise, host-A 110A may obtain the applicable firewall rule(s) from SDN manager 184. For example, at 250 in FIG. 2, host-A 110A (e.g., using VM agent 152) may detect a login event associated with second user 192 operating second user device 194 to log onto VM2 132. In response to detecting login event 250, VM agent 152 may send the attribute information (see ATT(Y)=ATT-2) associated with second user 192 to DFW engine 118A. See also 260 in FIG. 2.

At 270-280 in FIGS. 2 and 340 in FIG. 3, in response to determination that second user 192 is not associated with ATT-1, host-A 110A (e.g., using DFW engine 118A) may obtain, from SDN manager 184, second firewall rule(s) configured for a second attribute information associated with second user 192. See (ATT-2, FWR-2) shown at 202. This way, at 350 in FIG. 3, host-A 110A (e.g., using DFW engine 118A) may apply the second firewall rule(s) to allow or block packet forwarding from, or towards, VM2 132. Using FWR-2 as an example, any packet(s) from VM2 132 to access patient records will be blocked by DFW engine 118A.

As used herein, the term “attribute information” may refer generally to any suitable attribute(s) based on which firewall rule(s) are configurable. Attribute information associated with user 191/192 may include, but not limited to, identity and/or group membership information associated with user 191/192. In general, although firewall rule(s) may be configured based on a single user's identity information, user's group membership information is usually used. Additionally or alternatively, the attribute information may include one or more of the following: configuration information (e.g., OS version) associated with VM 131/132, configuration information associated with an application or process (e.g., APP 141/142) running on VM 131/132, hardware and/or software information associated with user device 193/194 and location information associated with user device 193/194.

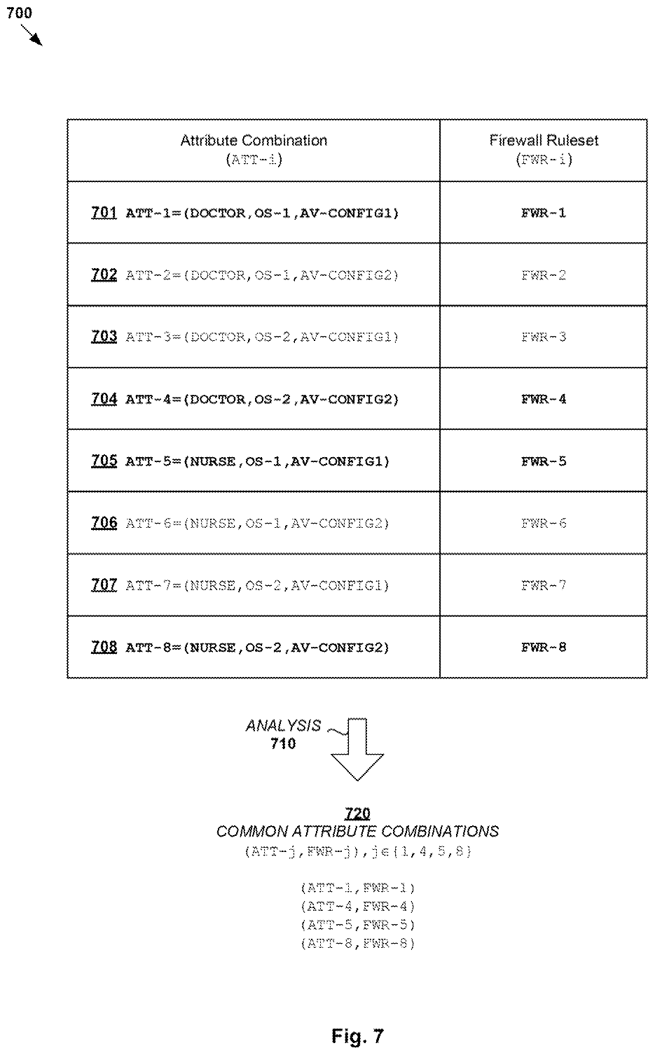

In the following, “attribute information” will be exemplified using “attribute combinations,” each being a combination of at least two attributes of the same attribute type (e.g., group combination at 201-20N in FIG. 2) or different types (e.g., group and configuration combination at 701-708 in FIG. 7).

Detailed Examples

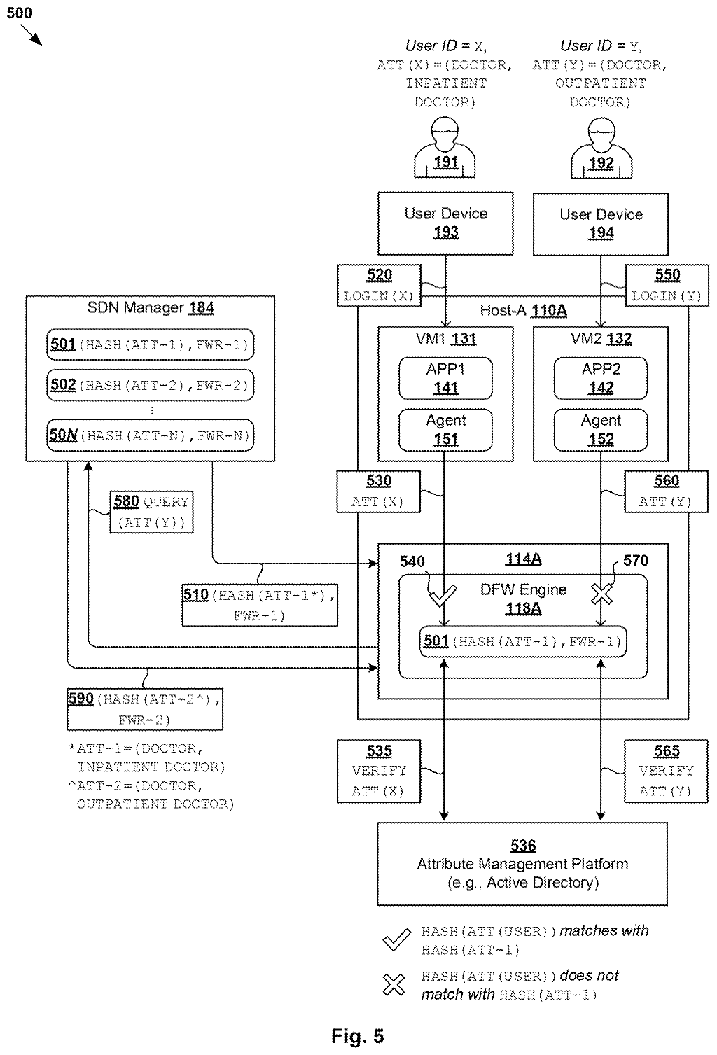

FIG. 4 is a flowchart of example process 400 of attribute-based firewall rule enforcement in SDN environment 100. Example process 400 may include one or more operations, functions, or actions illustrated at 410 to 490. The various operations, functions or actions may be combined into fewer blocks, divided into additional blocks, and/or eliminated depending on the desired implementation. The example in FIG. 4 will be discussed using FIG. 5, which is a schematic diagram illustrating first example 500 of attribute-based firewall rule enforcement in SDN environment 100.

(a) First Firewall Rule(s)

At 410 in FIG. 4, SDN manager 184 (or another management entity) may configure multiple (N) sets of one or more firewall rules (each set denoted as FWR-i, i=1, . . . ,N) based on respective sets of attribute information (ATT-i, i=1, . . . ,N). Here, FWR-i denotes firewall rule(s) configured based on the i^{th} attribute information (ATT-i). For example in FIG. 5, 501-50N are related to 201-20N in FIG. 2 where, such as ATT-1 is a combination of two groups=(DOCTOR, INPATIENT DOCTOR), ATT-2=(DOCTOR, OUTPATIENT DOCTOR), and so on. In practice, the term “group” may refer generally to a collection of members that can be managed as a single unit, such as doctors, nurses, etc. Using nesting, a group (e.g., IN/OUTPATIENT DOCTOR) may be a member of another group (e.g., DOCTOR).

At 415 in FIG. 4, SDN manager 184 may perform an analysis to select at least one “common attribute combination” (ATT-j, FWR-j) from the multiple sets of (ATT-i, FWR-i), where i=1, . . . ,N and j∈{1, . . . , N}. The selection at block 415 may be based on any suitable selection criterion or criteria, such as real-world occurrence associated with ATT-j among all possible combinations, real-world occurrence associated with ATT-j on single host-A 110A or across multiple hosts 110A-B, etc. For simplicity in FIG. 5, ATT-1 (i.e., j=1) may be identified to be a more “common attribute combination” among all sets of 501-50N. Any suitable analysis may be performed at block 415, such as machine learning, analysis using a rule engine, etc.

At 420-425 in FIG. 4, SDN manager 184 may push first firewall rule(s)=FWR-1 configured based on first attribute combination=ATT-1 towards multiple hosts 110A-B. Referring to 510 in FIG. 5, (hash(ATT-1), FWR-1) may be pushed towards host-A 110A, where hash value=hash(ATT-1) is calculated by applying a hash function on ATT-1. At host-A 110A, DFW engine 118A may store (hash(ATT-1), FWR-1) obtained from SDN manager 184 to facilitate subsequent rule enforcement.

By selecting and pushing (ATT-j, FWR-j) towards host-A 110A, the efficiency and scalability relating to firewall rule enforcement may be improved. Unlike conventional approaches, examples of the present disclosure do not necessitate SDN manager 184 to push all firewall rules for different attribute combinations towards hosts 110A-B. Further, by pushing and storing (hash(ATT-j), FWR-j), a hash value of a user's attribute information may be calculated and mapped to hash(ATT-1) during firewall rule enforcement to improve efficiency (to be discussed further below).

(b) Login Event

At 430-435 in FIG. 4, in response to detecting a login event associated with user 191 operating user device 193 to log onto VM1 131, agent 151 may generate and send attribute information (denoted as ATT(USER) in FIG. 4) associated with user 191 to DFW engine 118A. In the example in FIG. 5, user 191 with user ID=X is associated with ATT(USER=X)=(DOCTOR, INPATIENT DOCTOR), which is the same as ATT-1. See 520-530 in FIG. 5.

In practice, the login process may involve authenticating user 191 using any suitable identity management solution, such as Active Directory™ from Microsoft Corporation, VMware Identity Manager™ from VMware, Inc., etc. For example, user 191 may log onto VM1 131 using any suitable Active Directory credentials, such as a user ID, password, etc. Agent 151 (also known as a “thin agent” or “guest agent”) may be configured to capture events (e.g., login, logout, resource access, etc.) associated with VM1 131. Agent 151 may be configured to interact with hypervisor 114A (e.g., DFW engine 118A) using a communication channel between VM1 131 and hypervisor-A 114A, such as a Virtual Machine Communication Interface (VMCI) channel, etc. Agent 151 may also report identity information (e.g., user ID=X, IP address=IP1) to DFW engine 118A.

Depending on the desired implementation, virtual desktop infrastructure (VDI) may be implemented to allow user 191/192 to host a desktop OS on VM 131/132 (i.e., VM -based desktop). In general, VDI is a technology developed to provide virtual rather than physical desktops to users, who may connect to the virtual desktops from different locations using different user devices. Further, using identity-based firewall, firewall rules may be configured to provide granular per-user access to application(s) using the virtual desktops.

(c) Verification

At 440-445 in FIG. 4, in response to detecting the login event and obtaining attribute information ATT(X) from agent 151, DFW engine 118A may perform an independent verification of ATT(X) as a defense against identity/attribute spoofing by a malicious user. In the example in FIG. 5, block 445 may involve DFW engine 118A generating and sending a query to an attribute management platform (see 535-536), such as an Active Directory identity management platform, etc. This is to verify whether ATT(X) is correct and user 191 is indeed a member of (DOCTOR, INPATIENT DOCTOR) as notified by agent 151.

At 450 in FIG. 4, in response to a failed verification of ATT(X), remediation action(s) may be performed, such as by isolating VM1 131 (e.g., blocking all traffic), generating and sending a notification to a network administrator, etc. Otherwise, in response to a successful verification of ATT(X), DFW engine 118A may proceed to block 455 (to be discussed below).

For identity-based firewall, firewall rules are usually configured for groups instead of specific users. For example, suppose a genuine user is a member of group=DOCTOR, which in turn is a member of 300 groups. During the login process, membership of 300+1 groups may be identified. By performing the verification, spoofing becomes more difficult because a malicious user would have to know the exact group membership of 300+1 groups. The likelihood of successful spoofing would also decrease as the combination of multiple attributes (i.e., not just groups) becomes more complex.

At 455-460 in FIG. 4, in response to a successful verification of ATT(X), DFW engine 118A may retrieve firewall rule(s) applicable to user 191. This may involve calculating a hash value by applying a hash function (i.e., the same hash function used by SDN manager 184) on ATT(X)=(DOCTOR, INPATIENT DOCTOR). The hash value, e.g., hi=HASH(ATT(X)), is then mapped to HASH (ATT-1) obtained from SDN manager 184.

(d) Match Found Based on Hash Value

At 465 in FIG. 4, if there is a match between hi=HASH (ATT(X)) and HASH(ATT-1), DFW engine 118A may apply FWR-1 to allow or block subsequent packet forwarding towards/from VM1 131. In a first scenario in FIG. 5, hi=HASH(ATT(X)) matches with HASH (ATT-1), in which case corresponding FWR-1 may be applied to subsequent packet(s) from VM1 131. See 540 (match found) in FIG. 5.

(e) Match Not Found

Otherwise, at 470, 475 and 480 in FIG. 4, DFW engine 118A may obtain the relevant firewall rule(s) from SDN manager 184. In a second scenario in FIG. 5, consider a second login event by user 192 with user ID=Y and second attribute information=ATT(Y). In this case, agent 152 may report ATT(Y) to DFW engine 118A, along with identity information (user ID=Y, IP address=IP2) associated with user 192. DFW engine 118A may then proceed to verify ATT(Y) with attribute management platform 536. Once verified, DFW engine 118A may calculate h2=HASH(ATT(Y)) and attempt to map h2 to HASH(ATT-1). See 550, 560 and 565 in FIG. 5.

Since ATT(Y)=(DOCTOR, OUTPATIENT DOCTOR) associated with second user 192 is different from ATT-1=(DOCTOR, INPATIENT DOCTOR), it is determined that there is no match. As such, DFW engine 118A may generate and send a request or query identifying ATT(Y) to SDN manager 184, which performs a search and responds with (HASH(ATT-2), FWR-2). Here, FWR-2 denotes second firewall rule(s) configured based on second attribute information denoted as ATT(Y)=ATT-2. See 570 (no match), 580 and 590 in FIG. 5.

Firewall Rule Enforcement

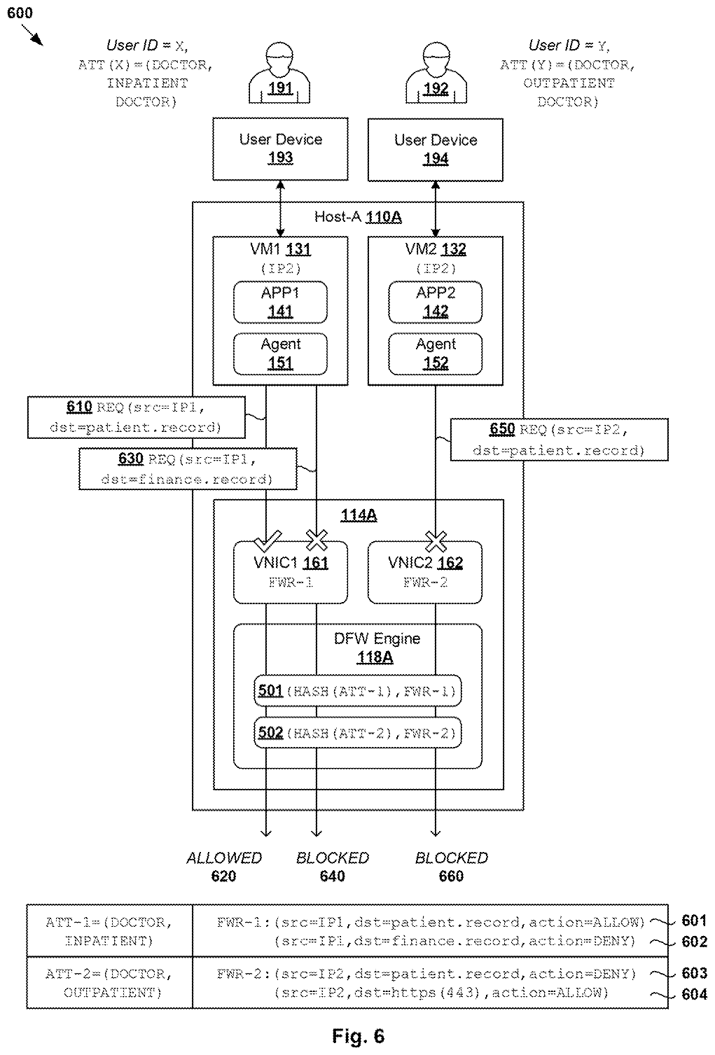

Blocks 465, 485 and 490 in FIG. 4 will be explained using FIG. 6, which is a schematic diagram illustrating second example 600 of attribute-based firewall rule enforcement in SDN environment 100. In practice, firewall rules may be applied along a datapath between VM 131/132 and another endpoint, such as at a VNIC level. For example, first firewall rules (FWR-1) may be applied at VNIC1 161 to which VM1 131 is connected, and second firewall rules (FWR-2) at VNIC2 162 connected with VM2 132.

(a) First Firewall Rule(s)

At 601-602 in FIG. 6, for first user 191 and VM1 131, FWR-1 configured based on ATT-1=(DOCTOR, INPATIENT DOCTOR) may include (source=IP1, destination=patient.record, action=allow) to allow database access to patient records. FWR-1 may further include (source=IP1, destination=finance.record, action=block) to block database access to finance records.

At 610-620 in FIG. 6, in response to detecting a packet requesting access to patient record(s) from VM1 131 with source IP address=IP1, DFW engine 118A may apply firewall rule 601 to allow the access. In contrast, at 630-640, in response to detecting another packet requesting access to finance record(s) from VM1 131, DFW engine 118A may apply firewall rule 602 to block the access.

(b) Second Firewall Rule(s)

At 603-604 in FIG. 6, for second user 192, FWR-2 configured based on ATT-2=(DOCTOR, OUTPATIENT DOCTOR) may include (source=IP2, destination=patient.record, action=block) to block database access to patient records. FWR-2 may further include (source=IP2, destination=https(443), action=block) to allow secure Internet access using hyperText transfer protocol (HTTP) secure (HTTPS) with port number=443.

At 650-660 in FIG. 6, in response to detecting a packet requesting access to patient record(s) from VM2 132 with IP address=IP2, DFW engine 118A may apply firewall rule 603 to block the access. In contrast, Internet access (not shown) using HTTPS and port number=443 will be allowed based on firewall rule 604.

In practice, “destination=patient.record” may be further translated to a destination IP address associated with a database storing the patient records. The same applies to “destination=finance.record.” Each firewall rule may further specify any suitable match field(s), such as protocol information (e.g., TCP, UDP) and associated source and/or destination port numbers.

Common Attribute Combinations

FIG. 7 is a schematic diagram illustration example selection 700 of common attribute combinations for attribute-based firewall rule enforcement. In this example, attribute information may be a combination of multiple attribute types, such as identity or group membership information (e.g., DOCTOR or NURSE) associated with user 191/192 and configuration information associated with VM 131/132, such as an OS version (e.g., OS-1 or OS-2) running on VM 131/132 and an antivirus (AV) configuration (e.g., AV-CONFIG1 or AV-CONFIG2) associated with the OS version.

At 701-708 in FIG. 7, eight different combinations of (group, OS version, AV configuration) are shown, such as ATT-1=(DOCTOR, OS-1, AV-CONFIG1), ATT-2=(DOCTOR, OS-1, AV-CONFIG2), ATT-3=(DOCTOR, OS-2, AV-CONFIG1), and so on. Although there are eight combinations, only certain combination(s) may be implemented in real-world situation. For example, based on real-world occurrence, OS-1 may be most commonly associated with AV-CONFIG1 (e.g., AV enabled) by default, while OS-2 may be most commonly associated with AV-CONFIG2 (e.g., AV disabled).

At 710 in FIG. 7, the analysis performed by SDN manager 184 according to block 415 in FIG. 4 may include selecting combination(s) that have a substantially high occurrence in the real world compared to other combination(s). Based on the above example, SDN manager 184 may identify or predict (OS-1, AV-CONFIG1) and (OS-2, AV-CONFIG2) to be more common compared to (OS-1, AV-CONFIG2) and (OS-2, AV-CONFIG1).

At 720 in FIG. 7, based on the above analysis, SDN manager 184 may select the following attribute combinations towards hosts 110A-B: ATT-1=(DOCTOR, OS-1, AV-CONFIG1), ATT-4=(DOCTOR, OS-2, AV-CONFIG2), ATT-5=(NURSE, OS-1, AV-CONFIG1) and ATT-8=(NURSE, OS-2, AV-CONFIG2). By pushing a subset of the total of eight combinations towards hosts 110A-B, the number of corresponding firewall rules maintained by hosts 110A-B may be reduced. This in turn improves the efficiency of mapping a particular user's attribute information to one of (ATT-1, ATT-4, ATT-5, ATT-8) to identify corresponding (FWR-1, FWR-4, FWR-5, FWR-8).

In practice, there might be a large number of attribute combinations due to tens of attributes that are used for security policy configuration. By selecting only the most common attribute combinations, it is not necessary for hosts 110A-B to maintain a very large number of firewall rules in anticipation of all possible attribute combinations. In some cases, if DFW engine 118A detects that a particular user is associated with a peculiar combination that is deviates from the most common attribute combinations, an alert may be sent to a network administrator to report the anomaly.

Example Use Cases

Examples of the present disclosure may be implemented to address various potential issues relating to firewall rule enforcement in SDN environment 100. Some examples are discussed below.

(1) Although one user 191/192 per VM 131/132 is shown in FIGS. 5-6, multiple users (e.g., 100 users) might log onto the same VM1 131 (e.g., VDI machine). Conventionally, host 110A/110B might have to fetch firewall rules from SDN manager 184 every time there is a login event. Using examples of the present disclosure, common attribute combinations among the users may be identified such that corresponding firewall rules may be cached on host 110A/110B. This reduces traffic to SDN manager 184 every time there is a login event or a burst of login events.

(2) Conventionally, it might take a few seconds to minutes for host-A 110A to fetch firewall rules from SDN manager 184 after a user's login event. Until the firewall rules are fetched, default rules might have to be applied. Although login events are generally infrequent, they might occur in burst (e.g., VDI login storms). One possible scenario is when a pool of VMs is allocated to an enterprise (e.g., hospital) and many users might log in at the same time. Using examples of the present disclosure, firewall rules (e.g., FWR-1) may be obtained from SDN manager 184 and cached prior to a login event, thereby improving efficiency. This also improves data center security, especially within the time period required to fetch firewall rules in a VDI environment.

(3) Conventionally, firewall rule translation is usually performed every time a VM migration occurs, such as VM1 131 migrating from host-A 110A to host-B 110B. In some cases, VM migration might occur very often, which increases the cost of firewall rule translation. Using examples of the present disclosure, firewall rules associated with common attribute combinations (e.g., ATT-1) may be pushed to multiple hosts 110A-B to reduce the translation cost.

(4) In practice, identity spoofing is a security concern that is often raised by data center users and security teams. Using examples of the present disclosure, DFW engine 118A may verify any attribute information received from agent 151/152 running on VM 131/132 to reduce the likelihood of attribute (e.g., identity) spoofing.

(5) Using examples of the present disclosure, firewall rule enforcement may be performed based on various types of attribute information, i.e., not limited to identity or group membership information associated with a user. This facilitates enhanced firewall rule configuration for different attribute combinations to further improve security in SDN environment 100.

Container Implementation

Although explained using VMs 131-134, it should be understood that public cloud environment 100 may include other virtual workloads, such as containers, etc. As used herein, the term “container” (also known as “container instance”) is used generally to describe an application that is encapsulated with all its dependencies (e.g., binaries, libraries, etc.). In the examples in FIG. 1 to FIG. 7, container technologies may be used to run various containers inside respective VMs 131-134. Containers are “OS-less”, meaning that they do not include any OS that could weigh 10s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies. The containers may be executed as isolated processes inside respective VMs.

Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 7. For example, a computer system capable of acting as host 110A/110B or management entity 184 may be deployed in SDN environment 100.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

What is claimed is:

1. A method for a computer system to perform attribute-based firewall rule enforcement, wherein the method comprises:
obtaining, from a management entity, one or more first firewall rules configured based on first attribute information;
detecting a login event associated with a user operating a user device to log onto a virtualized computing instance supported by the computer system;
in response to determination that the user is associated with the first attribute information, applying the one or more first firewall rules to allow or block packet forwarding from, or towards, the virtualized computing instance;
otherwise, in response to determination that the user is associated with second attribute information that is different from the first attribute information,
obtaining, from the management entity, one or more second firewall rules configured based on the second attribute information; and
applying the one or more second firewall rules to allow or block packet forwarding from, or towards, the virtualized computing instance.

2. The method of claim 1, wherein obtaining the one or more first firewall rules comprises:
obtaining, from the management entity, the one or more first firewall rules configured for the first attribute information, being a more common attribute combination compared to the second attribute information.

3. The method of claim 2, wherein obtaining the one or more first firewall rules comprises:
obtaining the one or more first firewall rules based on a selection of the first attribute information by the management entity, wherein the first attribute information is selected based on at least one of following selection criteria: (a) real-world occurrence associated with the first attribute information among all possible attribute combinations, and (b) occurrence associated with the first attribute information on the computer system or across multiple computer systems.

4. The method of claim 1, wherein obtaining the one or more first firewall rules comprises:
obtaining, from the management entity, the one or more first firewall rules along with a first hash value calculated based on the first attribute information.

5. The method of claim 4, wherein determination that the user is associated with the first attribute information comprises:
obtaining, from an agent running on the virtualized computing instance, particular attribute information associated with the user; and
calculating a particular hash value based on the particular attribute information to determine whether there is a match with the first hash value obtained from the management entity.

6. The method of claim 5, wherein determination that the user is associated with the first attribute information comprises:
obtaining the particular attribute information that includes one or more of the following: identity or group membership information associated with the user, configuration information associated with the virtualized computing instance, configuration information associated with an application or process running on the virtualized computing instance, hardware or software information associated with the user device and location information associated with the user device.

7. The method of claim 1, wherein the method further comprises:
prior to applying the one or more first firewall rules, verifying the first attribute information with an attribute management platform.

8. A non-transitory computer-readable storage medium that includes a set of instructions which, in response to execution by a processor of a computer system, cause the processor to perform a method of attribute-based firewall rule enforcement, wherein the method comprises:
obtaining, from a management entity, one or more first firewall rules configured based on first attribute information;
detecting a login event associated with a user operating a user device to log onto a virtualized computing instance supported by the computer system;
in response to determination that the user is associated with the first attribute information, applying the one or more first firewall rules to allow or block packet forwarding from, or towards, the virtualized computing instance;
otherwise, in response to determination that the user is associated with second attribute information that is different from the first attribute information,
obtaining, from the management entity, one or more second firewall rules configured based on the second attribute information; and
applying the one or more second firewall rules to allow or block packet forwarding from, or towards, the virtualized computing instance.

9. The non-transitory computer-readable storage medium of claim 8, wherein obtaining the one or more first firewall rules comprises:
obtaining, from the management entity, the one or more first firewall rules configured for the first attribute information, being a more common attribute combination compared to the second attribute information.

10. The non-transitory computer-readable storage medium of claim 9, wherein obtaining the one or more first firewall rules comprises:
obtaining the one or more first firewall rules based on a selection of the first attribute information by the management entity, wherein the first attribute information is selected based on at least one of following selection criteria: (a) real-world occurrence associated with the first attribute information among all possible attribute combinations, and (b) occurrence associated with the first attribute information on the computer system or across multiple computer systems.

11. The non-transitory computer-readable storage medium of claim 8, wherein obtaining the one or more first firewall rules comprises:
obtaining, from the management entity, the one or more first firewall rules along with a first hash value calculated based on the first attribute information.

12. The non-transitory computer-readable storage medium of claim 11, wherein determination that the user is associated with the first attribute information comprises:
obtaining, from an agent running on the virtualized computing instance, particular attribute information associated with the user; and
calculating a particular hash value based on the particular attribute information to determine whether there is a match with the first hash value obtained from the management entity.

13. The non-transitory computer-readable storage medium of claim 12, wherein determination that the user is associated with the first attribute information comprises:
obtaining the particular attribute information that includes one or more of the following: identity or group membership information associated with the user, configuration information associated with the virtualized computing instance, configuration information associated with an application or process running on the virtualized computing instance, hardware or software information associated with the user device and location information associated with the user device.

14. The non-transitory computer-readable storage medium of claim 8, wherein the method further comprises:
prior to applying the one or more first firewall rules, verifying the first attribute information with an attribute management platform.

15. A computer system, comprising:
a distributed firewall engine to obtain, from a management entity, one or more first firewall rules configured based on first attribute information; and
a virtualized computing instance to detect a login event associated with a user operating a user device to log onto the virtualized computing instance;
wherein the distributed firewall engine is further to:
in response to determination that the user is associated with the first attribute information, apply the one or more first firewall rules to allow or block packet forwarding from, or towards, the virtualized computing instance;
otherwise, in response to determination that the user is associated with second attribute information that is different from the first attribute information, obtain, from the management entity, one or more second firewall rules configured based on the second attribute information; and apply the one or more second firewall rules to allow or block packet forwarding from, or towards, the virtualized computing instance.

16. The computer system of claim 15, wherein the distributed firewall engine is to obtain the one or more first firewall rules by performing the following:
obtain, from the management entity, the one or more first firewall rules configured for the first attribute information, being a more common attribute combination compared to the second attribute information.

17. The computer system of claim 16, wherein the distributed firewall engine is to obtain the one or more first firewall rules by performing the following:
obtain the one or more first firewall rules based on a selection of the first attribute information by the management entity, wherein the first attribute information is selected based on at least one of following selection criteria: (a) real-world occurrence associated with the first attribute information among all possible attribute combinations, and (b) occurrence associated with the first attribute information on the computer system or across multiple computer systems.

18. The computer system of claim 15, wherein the distributed firewall engine is to obtain the one or more first firewall rules by performing the following:
obtaining, from the management entity, the one or more first firewall rules along with a first hash value calculated based on the first attribute information.

19. The computer system of claim 18, wherein the distributed firewall engine is to determine that the user is associated with the first attribute information by performing the following:
obtain, from an agent running on the virtualized computing instance, particular attribute information associated with the user; and
calculate a particular hash value based on the particular attribute information to determine whether there is a match with the first hash value obtained from the management entity.

20. The computer system of claim 19, wherein the distributed firewall engine is to determine that the user is associated with the first attribute information by performing the following:
obtain the particular attribute information that includes one or more of the following: identity or group membership information associated with the user, configuration information associated with the virtualized computing instance, configuration information associated with an application or process running on the virtualized computing instance, hardware or software information associated with the user device and location information associated with the user device.

21. The computer system of claim 15, wherein the distributed firewall engine is further to:
prior to applying the one or more first firewall rules, verify the first attribute information with an attribute management platform.
